(19) United States
(12) Patent Application Publication
(10) Pub. No.: US 2026/0161934 A1
(43) Pub. Date: Jun. 11, 2026

(54) DATA PROCESSING METHOD AND ELECTRONIC DEVICE

(71) Applicant: Lenovo (Beijing) Limited, Beijing (CN)

(72) Inventors: Binsheng QUE, Beijing (CN); Ranjeet GUPTA, Chicago, IL (US)

(21) Appl. No.: 19/365,704

(22) Filed: Oct. 22, 2025

(30) Foreign Application Priority Data
Dec. 9, 2024 (CN) 202411808018.4

(51) Int. Cl. G06N 3/0475; G10L 15/16

(52) U.S. Cl. CPC G06N 3/0475; G10L 15/16

(57) ABSTRACT

A data processing method includes obtaining input data, obtaining descriptive data representing a restrictive condition, based on a target model, the input data, and the descriptive data, processing the input data to generate output data, and outputting the output data. The input data includes target data corresponding to the restrictive condition. The target model is a generative large language model. The output data does not include the target data corresponding to the restrictive condition.

### CROSS-REFERENCE TO RELATED APPLICATION

This application claims priority to Chinese Application No. 202411808018.4, filed on Dec. 9, 2024, the entire content of which is incorporated herein by reference.

### TECHNICAL FIELD

The present disclosure generally relates to the data processing technology field and, more particularly, to a data processing method and an electronic device.

### BACKGROUND

In related technologies, when processing input data based on a model, the model usually processes all input data according to a specific processing logic to obtain a processing result. Thus, the model behavior of processing the input data or the output result of the model are not controllable. In various implementations, the output result of the model often needs to be restricted to meet a specific requirement.

### SUMMARY

Embodiments of the present disclosure provide a data processing method. The method includes obtaining input data, obtaining descriptive data representing a restrictive condition, based on a target model, the input data, and the descriptive data, processing the input data to generate output data, and outputting the output data. The input data includes target data corresponding to the restrictive condition. The target model is a generative large language model. The output data does not include the target data corresponding to the restrictive condition.

Embodiments of the present disclosure provide an electronic device, including a first input assembly, a second input assembly, one or more processors, and an output assembly. The first input assembly is configured to obtain the input data. The second input assembly is configured to obtain descriptive data representing a restrictive condition. The input data includes target data corresponding to the restrictive condition. The one or more processors are configured to, based on a target model, the input data, and the descriptive data, process the input data to generate output data. The target model is a generative large language model. The output assembly is configured to output the output data. The output data does not include the target data corresponding to the restrictive condition.

Embodiments of the present disclosure provide a non-transitory computer-readable storage medium storing a computer program that, when executed by one or more processors, causes the one or more processors to obtain input data, obtain descriptive data representing a restrictive condition, based on a target model, the input data, and the descriptive data, process the input data to generate output data, and output the output data. The input data includes target data corresponding to the restrictive condition. The target model is a generative large language model. The output data does not include the target data corresponding to the restrictive condition.

### BRIEF DESCRIPTION OF THE DRAWINGS

FIG. 1 illustrates a schematic flowchart of a data processing method according to embodiments of the present disclosure.

FIG. 2 illustrates a schematic flowchart of a data processing method according to embodiments of the present disclosure.

FIG. 3 illustrates a schematic flowchart of a data processing method according to embodiments of the present disclosure.

FIG. 4 illustrates a schematic flowchart of a data processing method according to embodiments of the present disclosure.

FIG. 5 illustrates a schematic flowchart of a data processing method according to embodiments of the present disclosure.

FIG. 6 illustrates a schematic diagram of a content summary when two parties are in a call according to embodiments of the present disclosure.

FIG. 7 illustrates a schematic diagram of a content summary when two parties are in a call according to embodiments of the present disclosure.

FIG. 8 illustrates a schematic flowchart of a data processing method when two parties are in a call according to embodiments of the present disclosure.

FIG. 9 illustrates a schematic structural diagram of a data processing apparatus according to embodiments of the present disclosure.

FIG. 10 illustrates a schematic structural diagram of an electronic device according to embodiments of the present disclosure.

FIG. 11 illustrates a schematic diagram of a computer device according to embodiments of the present disclosure.

### DETAILED DESCRIPTION OF THE EMBODIMENTS

To make the objectives, technical solutions, and advantages of the present disclosure clearer, the technical solutions of the present disclosure are further described in detailed below in conjunction with the accompanying drawings and embodiments of the present disclosure. The described embodiments should not be considered as limitations of the present disclosure. All other embodiments obtained by those skilled in the art without creative efforts shall be within the scope of the present disclosure.

In the following description, “some embodiments” describe a subset of all possible embodiments. “Some embodiments” can be the same or different subsets of all possible embodiments and can be combined with each other when there is no conflict. The terms “first/second/third” are used to distinguish similar objects and do not represent a specific order. “First/second/third” can be interchanged in a specific sequence or order to implement the described embodiments of the present disclosure in sequences other than the sequence illustrated or described here.

Unless otherwise specified, all technical and scientific terms used herein have the same meaning as commonly understood by those skilled in the art. The terms used herein are merely intended to describe the present disclosure not limiting the present disclosure.

In the present disclosure, a “target model” can be a machine learning model, a large language model, or a generative large language model.

A machine learning model can recognize natural language and/or other inputs (such as audio, video, images, tables, etc.) fed into the target model, and perform comprehensive language processing tasks such as semantic analysis and question answering, thereby generating output related to the input and/or responding to the input.

A large language model is an artificial intelligence model based on deep learning technology. The large language model can learn the characteristics, rules, and patterns of natural language by training based on a large amount of diversified data, to understand and generate natural language texts. A large language model typically has billions to hundreds of billions of parameters, enabling it to capture complex relationships and patterns in natural language.

A generative large language model is mainly intended to generate natural language texts. A generative large language model can take a given input such as a sentence or a prompt and generate a response: coherent and contextually relevant sentences or even paragraphs based on a given prompt or input. The model uses various techniques, including attention mechanisms, transformers, and neural networks, to process the input and generate an output that aims to be coherent and contextually appropriate.

The generative large language model can learn the statistical rules of the language by analyzing a large amount of text data and generate a text conforming to grammatical and semantic rules based on the learned knowledge and the provided context or prompts. Generative large language models can enhance various applications like content generation, personalization, and multimodal content creation.

Generative large language model (GLM) can include, for example, large language model (LLM), generative pre-trained transformer (GPT), vision large model, multimodal large model, or expert large model obtained through fine-tuning based on specific needs. The present disclosure is not limited to these examples.

The output of the target model is not restricted. For example, if user privacy data or security-related data is input into the target model, the model processes the input based on processing logic determined through training, which may result in limited controllability of the output of the model. This could negatively impact the interaction between the user and the target model.

To restrict the processing result when processing the input data, embodiments of the present disclosure provide a data processing method. The method includes obtaining the input data, obtaining descriptive data representing a restrictive condition, processing the input data to generate output data based on the target model, the input data, and the descriptive data, and outputting the output data. The input data can include target data corresponding to the restrictive condition. The target model can be the generative large language model. The output data may not include the target data corresponding to the restrictive condition. Then, when processing the input data, the output data can be restricted through the descriptive data of the restrictive condition to cause the output data of the target model to not include the target data corresponding to the restrictive condition. Thus, the output data can be effectively restricted, which prevents the target model from outputting any output and effectively controls the output behavior of the target model. Then, the output data can meet the requirement.

Embodiments of the present disclosure provide a data processing method that can be executed by a processor of a computer device. The computer device can include a server, a laptop, a tablet, a desktop computer, a smart TV, a set-top box, a mobile device (e.g., a cell phone, a portable video player, a personal digital assistant, a dedicated messaging device, and a portable gaming device), or any devices with data processing capabilities.

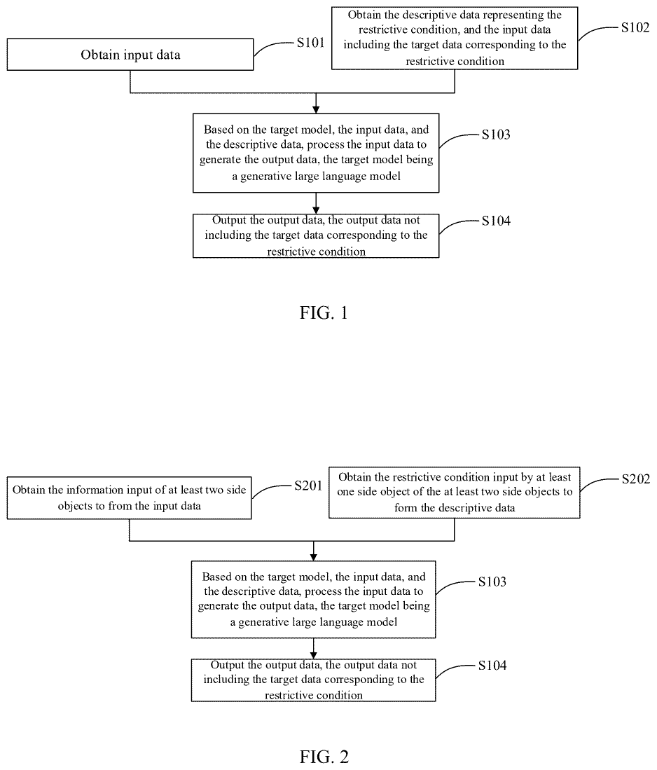

FIG. 1 illustrates a schematic flowchart of a data processing method according to embodiments of the present disclosure. As shown in FIG. 1, the method includes the following processes.

At S101, the input data is obtained.

The input data can be the data that needs to be processed.

In some embodiments, when at least two users are in a voice call, a call assistant of a user terminal device can record the voice of each user during the call. The voices of all the users can be used as input data to process the voice content.

In some embodiments, when at least two users are in a video call, the call assistant of the user terminal device can record a video call content. The video of all the users can be used as the input data to process the video content.

In some embodiments, when at least two users are in an online meeting, the call assistant of the user terminal device can record the voice of the meeting. The voice of all the users can be used as the input data to process the voice of the meeting.

In some embodiments, the input data can be data determined by at least one user. The data can include a voice, a video, or a text stored by the user. For example, the user can pre-store a segment of the voice as the input data.

At S102, the descriptive data representing the restrictive condition is obtained, and the input data includes the target data corresponding to the restrictive condition.

The descriptive data can be data about the restrictive condition. The restrictive condition can correspond to the target data of the input data. The target data can be data of the input data that is not allowed or needs to be processed. The output result can be restricted by the descriptive data.

In some embodiments, when at least two users are in the voice call, any one of the at least two users can propose a restrictive condition about processing the call voice. The restrictive condition can be used as the descriptive data.

In some embodiments, when at least two users are in the video call, any one of the at least two users can propose a restrictive condition about processing the video. The restrictive condition can be used as the descriptive data.

In some embodiments, when at least two users are in the online meeting, any one of the at least two users can propose the restrictive condition about processing the meeting voice. The restrictive condition can be used as the descriptive data.

In some embodiments, the descriptive data can be data determined by at least one user. The descriptive data can be predetermined by the user for the input data. For example, if the user needs to summarize a saved voice segment, the descriptive data can specify the content that cannot be summarized for the voice.

For example, when the input data is the call voice of at least two users, the descriptive data can include name and location information from the call voice that cannot be summarized.

At S103, based on the target model, the input data, and the descriptive data, the input data is processed to generate the output data. The target model is a generative large language model.

After obtaining the input data and the descriptive data of the restrictive condition, the input data can be processed based on the target model, the input data, and the descriptive data to generate the output data.

In some embodiments, the target model can be the generative large language model. The generative large language model can process the input data to generate summary or abstract, thus obtaining a summary or abstract corresponding to the input data. For example, a text segment can be inputted into the generative large language model, and the generative large language model can output (generate) the summary corresponding to the text.

In some embodiments, the target model can be other neural network models, such as convolutional neural networks, recurrent neural networks, etc.

In some embodiments, the target data of the input data can be determined based on the descriptive data. The target data can be cleaned from the input data to obtain the cleaned input data. The cleaned input data can be then inputted into the target model to generate the output data.

In some embodiments, the input data and the descriptive data can be inputted into the target model together. The target model can process the input data based on the descriptive data to generate the output data. The target model can process the input data in an arbitrary method, as long as the output data is ensured to not include the target data corresponding to the restrictive condition.

At S104, the output data is output. The output data does not include the target data corresponding to the restrictive condition.

After generating the output data in the previous step, the output data may need to be outputted. The output data can be the processed data of the input data and may not include the target data corresponding to the restrictive condition.

For example, the input data can be the voice of user 1 and user 2. The generative large language model can summarize the voice content. The descriptive data can specify that the phone number and location information in the voice of user 1 voice cannot be summarized. After processing the input voice, the output data may not include the phone number and location information in the voice of user 1.

In embodiments of the present disclosure, the input data can be obtained. The descriptive data representing the restrictive condition can be obtained. The input data can include the target data corresponding to the restrictive condition. Based on the target model, input data, and descriptive data, the input data can be processed to generate the output data. The target model can be the generative large language model. The output data can be outputted, and the output data may not include the target data corresponding to the restrictive condition. Then, when processing the input data, the output data can be restricted by the descriptive data of the restrictive condition to ensure that the output data of the target model does not include the target data corresponding to the restrictive condition. Thus, the output data can be effectively restricted, which avoids the target model to output a result arbitrarily and effectively controls the output behavior of the target model. The output data can meet the requirement.

FIG. 2 illustrates a schematic flowchart of a data processing method according to embodiments of the present disclosure. The method can be executed by the processor of the computer device. Based on FIG. 1, S101, S101 and S102 of FIG. 1 are updated to S201 and S202. As shown in FIG. 2, the method includes the following processes.

At S201, the information input of at least two side objects is obtained to from the input data.

In some embodiments, when at least two side objects are in a voice call, the smart device can record the call voice of the at least two side objects during the call to obtain a call voice of each side object of the at least two side objects. The call voice can be used as the information input of the object to form the input data.

In some embodiments, when at least two side objects are in a video call, the smart device can record the video of at least two side objects during the video call to obtain the video of each side object of the at least two side objects. The video can be used as the information input of the object to form the input data.

In some embodiments, when at least two side objects are in an online meeting, the smart device can record the voice of the at least two side objects during the meeting to obtain the voice of each side object of the at least two side objects. The voice can be used as the information input of the object to form the input data.

In some embodiments, the at least two side objects can be objects from the same device. At least two input boxes can be provided in the input data interface of the same device. Each input box can correspond to a side object. Each object can input the to-be-processed information in the corresponding input box to form the information input of the at least two side objects into the input data. The information input by different objects can be differentiated.

In some embodiments, the at least two side objects can be objects from the same device. One input box can be provided in the input data interface of the same device. Each side object can input the to-be-processed information in the input box. The information can be labeled for differentiation. The information input of the at least two side objects can form the input data.

At S202, the restrictive condition input by at least one side object of the at least two side objects is obtained to form the descriptive data.

The at least one party object of the at least two side objects can input the restrictive condition. The input restrictive condition can form the descriptive data.

In some embodiments, the at least two side objects can be the at least two objects in the voice call. During the voice call, at least one side object can restrict the call voice and input the restrictive condition. The input restrictive condition can form the descriptive data.

In some embodiments, the at least two side objects can be the at least two objects in a video call. During the video call, at least one side object can restrict the content of the video and input the restrictive condition. The input restrictive condition can form the descriptive data.

In some embodiments, the at least two side objects can be at least two objects in an online meeting. During the meeting, at least one side object can restrict the voice of the meeting and input the restrictive condition. The restrictive condition can form the descriptive data.

In some embodiments, the restrictive condition input by the at least one side object can restrict the information input of all side objects. For example, for user 1 and user 2 in a voice call, user 1 can propose the restrictive condition to restrict the location information in the voice of user 1 and user 2 (i.e., the output data not include the location information in the voice of user 1 and user 2).

In some embodiments, the restrictive condition input by at least one side object can only restrict the information input of a corresponding object. For example, for user 1 and user 2 in a voice call, user 1 can propose the restrictive condition. The restrictive condition can only be used to restrict the location information in the voice of user 1 (i.e., the output data excluding the location information in the voice of user 1) but cannot be used to restrict the location information in the voice of user 2 (i.e., the output data including the location information in the voice of user 2).

For example, in a voice call scenario between two parties, the call voice of each party user can be used as the information input to form the input data. The restrictive condition for the call voice input by one user can form the descriptive data.

In embodiments of the present disclosure, the information input of the at least two party objects can be obtained to form the input data. The restrictive condition input by the at least one party object of the at least two party objects can be obtained. The restrictive condition can form the descriptive data. Thus, the input data and the descriptive data can be obtained at the at least two party objects to improve the richness and diversity of the input data and the descriptive data.

In some embodiments, the restrictive condition from a first party object can be applied to a portion data of the input data that belongs to the first party object.

The first party object can be any one party object of the at least two party objects.

For the at least two party objects, each party object can include corresponding information input. The input data can include a portion data of each party object. The restrictive condition of the first party object can be only applied to the portion data of the input data that belongs to the first party object and cannot be applied to the portion data of other objects.

For example, for user 1 and user 2 in a voice call, the input data can include the voice of user 1 and the voice of user 2. User 1 can propose the restrictive condition. The restrictive condition can be only applied to the voice of user 1 and cannot be applied to the voice of user 2.

In embodiments of the present disclosure, the restrictive condition from the first party object can be applied to the portion data of the input data that belongs to the first party object. Then, the restrictive condition can only be applied to the portion data of the input data from the same object, which avoids the impact of the restrictive condition on other objects besides the object corresponding to the restrictive condition. Thus, the separation of authorities can be enhanced between different users to improve the targeting performance of the restrictive condition.

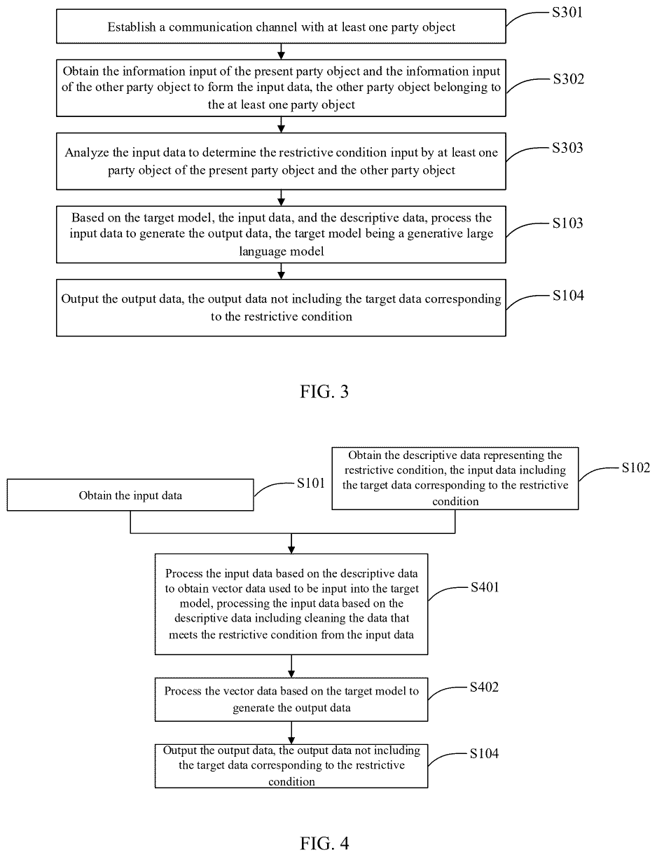

FIG. 3 illustrates a schematic flowchart of a data processing method according to embodiments of the present disclosure. The method can be executed by the processor of the computer device. Based on FIG. 2, S201 in FIG. 2 is updated to S301 and S302, and S202 in FIG. 2 is updated to S303. As shown in FIG. 3, the method includes the following processes.

At S301, a communication channel with at least one party object is established.

At least two party objects can exchange information. The input can be obtained based on the established communication channel to form the input data. The present party object may need to establish the communication channel with the at least one party object. Thus, the present party object can communicate with the at least one party object through the communication channel.

In some embodiments, when the at least two party objects are in the voice call, each party object can establish a channel for the voice call with the at least one party object.

In some embodiments, when the at least two party objects are in the video call, each party object can establish a channel for the video call with at least one party object.

In some embodiments, when the at least two party objects are in the online meeting, each party object can establish a channel for the meeting with at least one party object.

In some embodiments, when the at least two party objects perform SMS interaction, each party object can establish a channel for messaging with at least one party object.

At S302, the information input of the present party object and the information input of the other party object are obtained to form the input data. The other party object belongs to the at least one party object.

After the communication channel is established. The at least two party objects can communicate based on the communication channel. During the communication, the information input of the present party object and the information input of the other party object can be obtained based on the communication channel to form the input data. The other party object can belong to the at least one party object. The present party object can be the object that needs to process the input data.

In some embodiments, in a voice call scenario involving three party objects, each party object can establish a voice call channel with the other two party objects to perform the voice call. One party object may need to perform summarization on the voice contents of the three party objects. The one party object can serve as the present party object. The call assistant of the smart device can record the voices of the three party objects based on the communication channel to form the input data.

In some embodiments, when the at least two party objects are in the video call, the call assistant can obtain the video input of the present party object and the video input of the other party object based on the established video call channel to form the input data. The present party object can be the object that needs to summarize the video call content.

In some embodiments, when the at least two party objects are in the online meeting, the meeting assistant can obtain the meeting voice of the present party object and the meeting voice of the other party object based on the established meeting channel to form the input data. The present party object can be the object that needs to summarize the meeting content.

At S303, the input data is analyzed to determine the restrictive condition input by at least one party object of the present party object and the other party object.

During the communication based on the communication channel, the at least one party object can add the restrictive condition of the object in the input data. Thus, the input data can be analyzed to determine the restrictive condition input by at least one party object of the present party object and the other party object. The method of analyzing the input data to obtain the restrictive condition can be arbitrary. For example, the input data can be inputted into a voice analysis model. The voice analysis model can process the data to obtain the restrictive condition.

In some embodiments, when the at least two party objects are in the voice call, at least one party object can add the restive condition in the voice. The voices of the at least two party objects can be analyzed to determine the restrictive condition input by the at least one party object.

In some embodiments, the at least two party objects are in the video call, at least one party object can add the restrictive condition in the video. The videos of the at least two party objects can be analyzed to determine the restrictive condition input by the at least one party object.

In some embodiments, when the at least two party objects are in the online meeting, at least one party object can add the restrictive condition in the meeting voice. The meeting voice of the at least two party objects can be analyzed to determine the restrictive condition input by the at least one party object.

In embodiments of the present disclosure, the communication channel can be established with at least one party object. The information input of the present party object and the information input of the other party object can be obtained to form the input data. The other party object can belong to the at least one party object. Thus, the input data can be obtained based on the communication channel of the at least two party objects. The input data can be analyzed to determine the restrictive condition of the at least one party object of the present party object and the other party object. Then, the restrictive condition can be stored in the input data. The input data can be analyzed to obtain the restrictive condition, which simplifies the step of obtaining the restrictive condition.

In some embodiments, if the other party object inputs a restrictive condition, a prompt indicator showing that a restrictive condition has been input by the other party object may be displayed on the current conversation page. The indicator may be an icon, the content of the corresponding restrictive condition, etc.

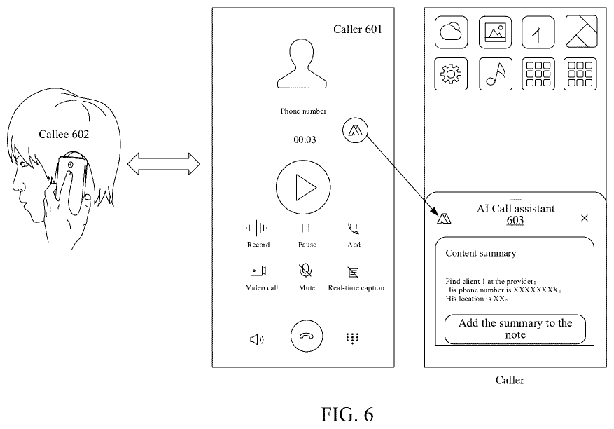

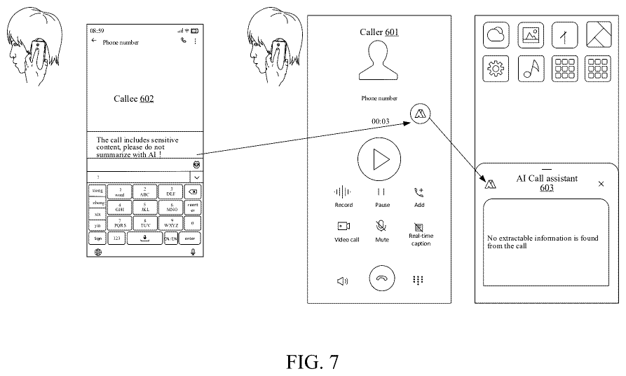

In some embodiments, if the other party object inputs a restrictive condition, an indicator showing that the other party object has input a restrictive condition may be displayed on a page summarized by artificial intelligence (AI) agent (AI agent) shown in FIG. 6 or FIG. 7. The indicator may be an icon, the content of the corresponding restrictive condition, etc. Agent, also referred to as an “assistant,” is an application of artificial intelligence technology and may be implemented based on the target model. The behavior of the agent can be determined by the target model according to the current state of the agent and external inputs. The target model can provide decision-making foundation for the agent through learning and training on large volumes of data. The agent may utilize tools, plugins, and knowledge bases to support reasoning, decision-making, and execution. The target model can provide decision support to the agent.

In some embodiments, obtaining the restrictive condition input by the at least one party object of the at least two party objects to form the descriptive data can include at least one of if the communication channel with the at least one party object is successfully established, obtaining the restrictive condition inputted by the other party object, if the communication channel with the at least one party object is disconnected, obtaining the restrictive condition inputted by the other party object, or obtaining the restrictive condition inputted by the other party object when the communication is performed based on the communication channel with the at least one party object.

In some embodiments, when the communication channel between the present party object and the at least one party object is successfully established, the other party object can know that the input data needs to be obtained and processed. Then, the other party object can provide the restrictive condition based on the currently established communication channel or other communication channels. For example, when the two parties are in the voice call, the present party object may need to record the call voice and summarize the content of the recording. When the present party object records the voice, the other party object can know that the present party object has started recording. Then, the other party object can provide the restrictive condition based on the channel of the voice call (e.g., the voice of the other party object not allowed to be summarized), or the present party object can be informed with the restrictive condition through messages.

In some embodiments, when the communication channel between the present party object and the at least one party object is disconnected, the other party object can know that the input data needs to be obtained and processed. Then, the other party object can provide the restrictive condition based on the currently established communication channel or other communication channels. For example, when the two parties are in the voice call, the present party object may need to record the call voice and summarize the content of the recording. After the call is disconnected, the voice call assistant can automatically send a data processing request to the other party object through messages. After the other party object receives the data processing request, the other party object can inform the present party object of the input restrictive condition through messages.

In some embodiments, when the present party object and the at least one party object are n the communication through the established communication channel, the other party object can know that the present party object is about to summarize the communication content from the communication content of the present party object. Then, the other party object can directly inform the present party object the restrictive condition inputted by the other party object based on the current communication method. For example, when the two parties are in the voice call, the present party object may need to record the call voice and summarize the content of the recording. The other party object may have been informed, and the other party object can directly inform the present party object the restrictive condition through the voice.

In some embodiments, when many people are in communication, the restrictive conditions inputted by different other party objects at different moments can be obtained. That is, for the first other party object, the restrictive condition of the other object can be obtained when the communication channel is successfully established. For the second other object, the restrictive condition of the other object can be obtained during establishing the communication channel for communication. For the third other party object, the restrictive condition of the other party object can be obtained when the communication channel is disconnected.

In embodiments of the present disclosure, by obtaining the restrictive conditions inputted by the other party object at different moments of performing the communication based on the communication channel, the variety in the methods of obtaining the restrictive condition can be improved. Thus, obtaining the restrictive condition can be more flexible.

In some embodiments, obtaining the descriptive data representing the restrictive condition can further include obtaining the descriptive data representing the restrictive condition in response to calling the target model.

After obtaining the input data, the input data may not be processed immediately, and the descriptive data of the restrictive condition may not be needed at this time. The descriptive data of the restrictive condition is only needed when the target model needs to be called to process the input data. Thus, the descriptive data representing the restrictive condition can be obtained in response to calling the target model.

The descriptive data can be the restrictive condition inputted by the at least one object corresponding to the input data.

For example, during a voice call between two party objects, the present party object can record the call voice of the two party objects. After the call ends, the content of the voice may not be necessarily summarized, and the descriptive data may not need to be obtained at this time. Only when the voice needs to be processed based on the target model, the descriptive data may need to be obtained.

In some embodiments, after obtaining the descriptive data representing the restrictive condition, if the target data corresponding to the restrictive condition is all the input data, the subsequent processing process can be stopped.

In embodiments of the present disclosure, the descriptive data representing the restrictive condition can be obtained in response to calling the target model. Then, the descriptive data can be obtained only when the target model is called to control accurate timing and avoid obtaining the invalid descriptive data. Thus, the efficiency and accuracy of data processing can be improved.

FIG. 4 illustrates a schematic flowchart of a data processing method according to some embodiments of the present disclosure. The method can be executed by the processor of the computer device. Based on FIG. 1, S103 in FIG. 1 is updated to S401 and S402. As shown in FIG. 4, the method includes the following processes.

At S401, the input data is processed based on the descriptive data to obtain vector data used to be input into the target model. Processing the input data based on the descriptive data includes cleaning the data that meets the restrictive condition from the input data.

When the input data is processed, the input data may need to be processed first based on the descriptive data to obtain the vector data that can be input into the target model. Then, the vector data can be processed based on the target model to generate the output data. When the input data is processed based on the descriptive data, the data that meets the restrictive condition may need to be cleaned from the input data to obtain the cleaned vector data.

In some embodiments, the descriptive data and the input data can be vectorized first, respectively, to obtain the vectorized descriptive data and input data. Then, based on the vectorized descriptive data, the data that meets the restrictive condition can be cleaned from the vectorized input data to obtain the cleaned vector data. Then, the vector data can be input into the target model for processing.

In some embodiments, the data that meets the restrictive condition can be cleaned from the input data based on the descriptive data first to obtain the cleaned input data. Then, the cleaned input data can be vectorized to obtain the vector data for input into the target model.

The data that meets the restrictive condition can be cleaned from the input data using the existing data cleaning technology. The existing data cleaning technology can be a data cleaning model.

For example, if the input data is a voice, the voice can be converted into text using the voice-to-text technology. The descriptive data can be text. For example, when the location information needs to be cleaned from the voice, the location information of the text corresponding to the voice can be cleaned to obtain the cleaned text for vectorization to obtain the vector data inputted into the target model.

At S402, the vector data is processed based on the target model to generate the output data.

After obtaining the cleaned vector data, the vector data can be inputted into the target model. The target model can be configured to process the vector data to generate the output data. The output data may not include the data corresponding to the restrictive condition.

For example, the vector data can be the call text after the location information is cleaned. The vector data can be inputted into the target model to obtain the summary corresponding to the call text. The summary may not include the location information.

In embodiments of the present disclosure, the input data can be processed based on the descriptive data to obtain the vector data used to be inputted into the target model. Processing the input data based on the descriptive data can include cleaning the data that meets the restrictive condition from the input data. The vector data can be processed based on the target model to generate the output data. Then, the data corresponding to the restrictive condition can be cleaned from the input data. The output data of the model may not include the data corresponding to the restrictive condition. Thus, the output result of the model can be effectively restricted.

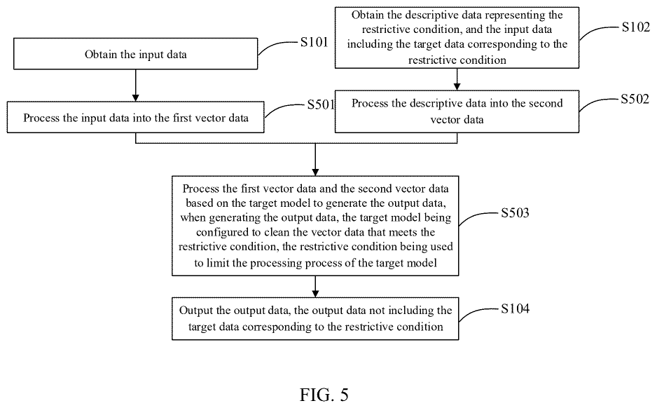

FIG. 5 illustrates a schematic flowchart of a data processing method according to embodiments of the present disclosure. The method can be executed by the processor of the computer device. Based on FIG. 1, S103 in FIG. 1 is updated to S501 to S503. As shown in FIG. 5, the method includes the following processes.

At S501, the input data is processed into the first vector data.

After the input data is obtained, the input data can be vectorized to obtain the first vector data.

For example, if the input data is voice, the voice can be first converted into text. Then, the text can be vectorized to obtain the first vector data.

At S502, the descriptive data is processed into the second vector data.

After the descriptive data is obtained, the descriptive data can be vectorized to obtain the second vector data.

In some embodiments, after the descriptive data is obtained, the description data can be parsed to obtain the parsed text. Then, the text can be vectorized to obtain the second vector data.

For example, if the descriptive data is text, the text can be directly parsed and vectorized to obtain the second vector data.

At S503, the first vector data and the second vector data are processed based on the target model to generate the output data. When generating the output data, the target model is configured to clean the vector data that meets the restrictive condition. The restrictive condition is used to limit the processing process of the target model.

After obtaining the first vector data corresponding to the input data and the second vector data corresponding to the descriptive data, the first vector data and the second vector data can be input into the target model. The target model can be configured to process the second vector data based on the first vector data to obtain the output data. When generating the output data, the target model can be configured to clean the vector data that meets the restrictive condition. The restrictive condition can be used to limit the processing process of the target model.

In some embodiments, the target model can first process the first vector data to obtain intermediate data. Then, based on the second vector data, the vector data corresponding to the restrictive condition can be removed from the intermediate data to obtain the output data.

In some embodiments, the target model can first clean the vector data corresponding to the restrictive condition from the first vector data based on the second vector data. Then, the cleaned first vector data can be cleaned to obtain the output data.

In embodiments of the present disclosure, the input data can be processed into the first vector data, and the descriptive data can be processed into the second vector data. The first vector data and the second vector data can be processed based on the target model to generate the output data. When generating the output data, the target model can clean the vector data that meets the restrictive condition. The restrictive condition can be used to limit the processing process of the target model. Thus, the generated output data may not include the data corresponding to the restrictive condition, which effectively limits the output result of the model.

In some embodiments, the target model is trained based on a large number of training samples, including input data samples, descriptive data samples, and output data samples. Each input data sample corresponds to a descriptive data sample and an output data sample. The target model is trained based on multiple sets of input data samples, descriptive data samples, and output data samples to obtain the trained target model.

In some embodiments, the target model can be trained based on a large number of training samples. A training sample can include an input data sample, a descriptive data sample, and an output data sample. Each input data sample can be in a one-to-one correspondence with the descriptive data sample and the output data sample. The target model can be trained based on a plurality of sets of input data samples, descriptive data samples, and output data samples to obtain the trained target model.

In some embodiments, a large number of input data samples and descriptive data samples can be constructed. Based on the descriptive data samples, the input data samples can be processed to obtain a large number of processed input data samples. Based on the large number of processed input data samples, and the output data samples, the target model can be trained to obtain the trained target model.

The applications of the data processing method in the actual scenarios are described below.

For an AI (artificial intelligent) large language model call assistant, in the related technology, the voice of the both parties can be converted to text using Automatic Speech Recognition (ASR) technology, and the text content can be input into the large language model for direct summarization and recording. Thus, both parties can use the large language model independently or simultaneously. Since both parties are not informed and are not able to control the large language model behavior of the other party, significant risks can be posed to the privacy, business, and even personal safety of the other party.

FIG. 6 illustrates a schematic diagram of a content summary for two way conversation according to embodiments of the present disclosure. As shown in FIG. 6, a caller 601 and a callee 602 are in a voice call. An AI call assistant 603 is provided in the voice call interface of the device of the caller. The AI call assistant 603 can record and convert the voice of the both parties into text and input the text into the large language model to obtain the summary of the voice content. Further, the summary can be added to the note. However, the content summary output by the AI call assistant can include some sensitive privacy information, such as phone numbers.

In embodiments of the present disclosure, the AI large language model call assistant can be controlled by both parties. If any party does not agree, the derivative summarization capability of the AI model of the other party can be limited or controlled. The response of the other party can be automatically used as a part of the input content of the large language model, and the model can be informed in the form of instructions to clean the input and with the encoding method. Thus, the final derivative and output of the assistant large language model can be output in the direction determined by the user.

In some embodiments, in the related technology, to prevent information leakage, the sensitive privacy information are usually blurred, which easily causes inconsistency of the information. For example, a part of the summary can be blurred, and the information may be inconsistent. In embodiments of the present disclosure, the input data and the restrictive condition can be processed based on the model. The output data may not include the target data corresponding to the restrictive condition. Thus, the output content of the model can be consistent and may not include the privacy information. The content output by the model can be controlled. No matter whether the output content is shared to a third party user, or the third party user actively obtains the output content, the output content can be safe. Compared to the related technology, in embodiments of the present disclosure, the restrictive information can be inputted into the model. The restrictive information can be from any one party user not preset by the device manufacturer at the production.

FIG. 7 illustrates a schematic diagram of a content summary for two way conversation according to embodiments of the present disclosure. As shown in FIG. 7, when the two parties are in a voice call, the callee 602 can send an instruction via SMS to summarize the call content. For example, the instruction can be “the call includes sensitive content, please do not summarize with AI.” After the AI call assistant 603 of the device of the caller 601 receives the SMS content, the SMS content can be parsed to determine that the content does not need to be summarized. The interface of the AI call assistant 703 can pop up a prompt information to indicate that no extractable information can be found from the call.

In some embodiments, the solution can include the following implementation steps.

Step 1, the call between the both parties starts, and the party that needs the summary automatically activates the AI call assistant at the mobile terminal device of the party.

Step 2, during the call, the activated AI call assistant records the voice and convert the voice into text to vectorize the stored recording. The vectorized call content includes text information of the present party and the other party. For example, the vector content is <caller: voice text> and <callee: voice text>. <caller: voice text> represents the voice text of the caller, and <callee: voice text> represents the voice text of the callee.

Step 3, after the call ends, the AI call assistant immediately sends an SMS to inform the other party to prepare to derive and summarize the call content.

Step 4, the response of the other party is ensured to be obtained within 5 min, including not allowing summarization, allowing partial content summarization (the party of the call assistant), and allowing all content summarization. The response is sent through SMS.

Step 5, the AI call assistant parses the content of the received SMS, and the SMS content is vectorized.

Step 6, embedded encoding can be performed on the received SMS encoding content and the ASR vector (the text vector corresponding to the voice) stored in the previous recording. The embedded encoding indicates of embedding the vectorized SMS content into the text vector of the voice to cause the object indicated by the SMS content to match the object of the voice text. For example, the SMS instruction vector for the caller is embedded into the voice text vector of the caller. The SMS instruction vector for the callee is embedded into the voice text vector of the callee.

Step 7, the ASR call content and the content received per the SMS are integrated to extract the input information of the final large language model. After the embedded encoding is completed, the embedded encoding content is further integrated. For example, the embedded encoding is adjusted into a predetermined encoding format, or the text vector that is not allowed to be summarized is directly hidden or deleted to obtain the input information that needs to be further cleaned and filtered for the large language model.

Step 8, the cleaning and filtering are performed on the vectorized content (i.e., the input information for the large language model in the last step) according to the instruction information. For example, the sensitive information is filtered.

Step 9, the cleaned content is inputted into the large language model to perform derivation and summarization.

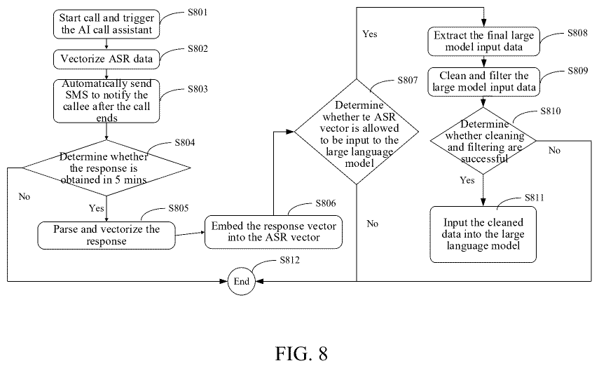

FIG. 8 illustrates a schematic flowchart of a data processing method when two parties are in a call according to embodiments of the present disclosure. As shown in FIG. 8, the method includes the following processes.

At S801, the call ends, and the AI call assistant is triggered.

At S802, the ASR data is vectorized.

After the voice is recorded, the voice can be converted into text and vectorized to obtain the text vector. For example, caller vector <caller: voice text> and callee vector <callee: voice text>.

At S803, the SMS text is automatically sent to notify the callee after the call ends.

The callee can be notified via SMS to perform the derivation and summarization.

At S 804, whether a response is obtained within 5 minutes is determined. If yes, proceed to step S805, and if no, proceed to step S812.

At S805, the response is parsed and vectorized.

The response of the other party may need to be parsed to identify the content of the response and vectorize the parsed content.

At S806, the response vector is embedded into the ASR vector.

At S807, whether the ASR vector is allowed to be input into the large language model is determined. If yes, proceed to step S808, and if no, proceed to step S812.

At S808, the final input data for the large language model is extracted.

The final input data for the large language model can include instructions (the response SMS content) and voice text (content to be summarized).

At S809, the input data for the large language model is cleaned and filtered.

The voice text can be cleaned and filtered based on the instructions.

At S810, whether the cleaning and filtering are successful is determined. If yes, proceed to step S811, and if no, proceed to step S812.

At S811, the cleaned data is input into the large language model.

At S812, end.

In some embodiments, the input content received by the large language model can include, in a first situation, no input and the callee not allowing the large language model to perform derivation and summarization, in a second situation, only the content of the caller {callee SMS instruction: caller voice text}, or in a third situation, the content of both parties {callee SMS instruction: caller voice text and callee voice text}.

In some embodiments, the callee SMS instruction can be used as a part of the large language model to clean the input content to inform the large language model to perform adjustment or content filtering in what kind of method and degree when performing the voice content derivation and summarization to prevent the large language model to perform arbitrary summarization and output. For example, if the received response SMS includes the instruction of “removing the cellphone number and location information in the call content of the present party,” the large language model can clean and filter out the sensitive and private content of the callee.

In embodiments of the present disclosure, the AI large language model behavior of both parties in the call can be judged and agreed upon by the other party, and the respective responses of both parties can be used as a part of the input for the large language model to effectively manage behavior of the large language model. The large language model can then behave as needed, and the malicious output can be prevented. The interests of both parties in the call can be effectively protected, and the leak of the privacy or business and financial information of the user can be further prevented.

Based on the above, embodiments of the present disclosure further provide a data processing apparatus. The apparatus can include units and modules included in the units, which can be implemented by one or more processors of the computer device, or a specific logical circuit. During the implementation, the one or more processors can include a Central Processing Unit (CPU), Microprocessor Unit (MPU), Digital Signal Processor (DSP), or Field Programmable Gate Array (FPGA), etc.

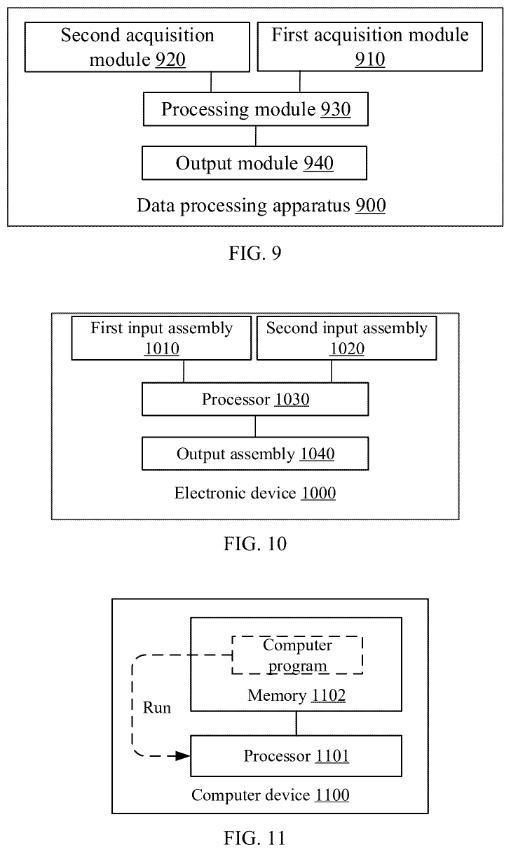

FIG. 9 illustrates a schematic structural diagram of a data processing apparatus 900 according to embodiments of the present disclosure. As shown in FIG. 9, the data processing device 900 includes a first acquisition module 910, a second acquisition module 920, a processing module 930, and an output module 940.

The first acquisition module 910 can be configured to obtain the input data.

The second acquisition module 920 can be configured to obtain the descriptive data representing the restrictive condition. The input data can include the target data corresponding to the restrictive condition.

The processing module 930 can be configured to process the input data based on the target model, input data, and descriptive data to generate the output data. The target model can be a generative large language model.

The output module 940 can be configured to output the output data. The output data may not include the target data corresponding to the restrictive condition.

In some embodiments, the first acquisition module 910 can be further configured to obtain the information input of the at least two party objects to form the input data. The second acquisition module 920 can be further configured to obtain the restrictive condition input by the at least one party object of the at least two party objects to form the descriptive data.

In some embodiments, the restrictive condition from the first party object can be applied to a part of the input data that belongs to the first party object.

In some embodiments, the first acquisition module 910 can be further configured to establish the communication channel with the at least one party object and obtain the information input of the present party object and the information input of the other party object to form the input data. The present party object can belong to the at least one party object. The second acquisition module 920 can be further configured to analyze the input data to determine the restrictive condition input by the at least one party object of the present party object and the other party object.

In some embodiments, the acquisition module 920 can be further configured to, if the communication channel with the at least one party object is successfully established, obtain the restrictive condition input by the other party object, if the communication channel with the at least one party object is disconnected, obtain the restrictive condition input by the other party object, and obtain the restrictive condition input by the other party object during the communication based on the communication channel with the at least one party object.

In some embodiments, the second acquisition module 920 can be further configured to obtain the descriptive data representing the restrictive condition in response to calling the target model.

In some embodiments, the processing module 930 can be further configured to process the input data based on the descriptive data to obtain the vector data to be input into the target model. Processing the input data based on the descriptive data can include cleaning the data that meets the restrictive condition from the input data. The processing module 930 can be further configured to process the vector data based on the target model to generate the output data.

In some embodiments, the processing module 930 can be further configured to process the input data into the first vector data, process the descriptive data into the second vector data, process the first vector data and the second vector data based on the target model to generate the output data. When the output data is generated, the target model can be configured to clean the vector data of the restrictive condition. The restrictive condition can be used to restrict the processing process of the target model.

The description of the above apparatus embodiments can be similar to the description of the above method embodiments and has similar beneficial effects. In some embodiments, the functions or modules included in the apparatus of embodiments of the present disclosure can be used to execute the methods described above. For the technical details not disclosed in the apparatus embodiments, reference can be made to the description of the method embodiments.

In embodiments of the present disclosure, if the data processing method is implemented in the form of software functional modules and sold or used as an independent product, the method can also be stored in a computer-readable storage medium. Based on this understanding, the essence of the technical solutions of the present disclosure or the part of the technical solutions contributing to the related technology can be embodied as software products. The software products can be stored in a storage medium and include several instructions used to cause one computer device (e.g., a personal computer, server, or network device, etc.) to execute all or a part of the methods of embodiments of the present disclosure. The storage medium can include a USB flash drive, a mobile hard drive, Read-Only Memory (ROM), magnetic disks, optical disks, and other media that can store program codes. Thus, embodiments of the present disclosure are not limited to any specific hardware, software, firmware, or any combination thereof.

Embodiments of the present disclosure provide a computer device, including a memory and a processor. The memory can store a computer program that, when executed by the processor, causes the processor to implement all of a part of the steps of the methods above.

Embodiments of the present disclosure provide the computer-readable storage medium storing a computer program that, when executed by the processor, causes the processor to implement all of a part of the steps of the methods above. The computer-readable storage medium can be transient or non-transient.

Embodiments of the present disclosure provide a computer program, including computer-readable codes. When the computer-readable codes are running in the computer device, the processor of the computer device can be executed all or a part of the steps of the methods above.

Embodiments of the present disclosure provide a computer program product. The computer program product can include a non-transient computer-readable storage medium storing the computer program that, when read and executed by a computer, causes the computer to implement all or a part of the steps of the methods above. The computer program product can be implemented by hardware, software, or a combination thereof. In some embodiments, the computer program product can be embodied as a computer storage medium. In some other embodiments, the computer program product can be embodied as a software product, such as a Software Development Kit (SDK).

The descriptions of the various embodiments above tend to emphasize the differences between the embodiments. The same or similar parts can be referred to each other. The descriptions of the above device, storage medium, computer program, and computer program product embodiments are similar to the description of the above method embodiments and have similar beneficial effects. For the technical details not disclosed in the device, storage medium, computer program, and computer program product embodiments of the present disclosure, reference can be made to the description of the method embodiments of the present disclosure.

FIG. 10 illustrates a schematic structural diagram of an electronic device 1000 according to embodiments of the present disclosure. As shown in FIG. 10, the electronic device 1000 includes a first input assembly 1010, a second input assembly 1020, a processor 1030, and an output assembly 1040.

The first input assembly 1010 can be configured to obtain the input data.

The second input assembly 1020 can be configured to obtain the descriptive data representing the restrictive condition. The input data can include the target data corresponding to the restrictive condition.

The processor 1030 can be configured to process the input data based on the target model, input data, and descriptive data to generate the output data. The target model can be the generative large language model.

The output assembly 1040 can be configured to output the output data. The output data may not include the target data corresponding to the restrictive condition.

The electronic device can be any device capable of executing the data processing method. For example, the electronic device can include a smartphone, tablet, computer, etc.

The input data can be the data that needs to be processed. The descriptive data can be the data about the restrictive condition. The restrictive condition can correspond to the target data in the input data. The target data can be data in the input data that is not allowed or needed to be processed. The descriptive data can restrict the final output result.

In some embodiments, the input data and descriptive data can be obtained through different input assemblies. For example, in a voice call scenario between at least two party objects, the present party object can establish a voice channel with the other party object and perform a voice call based on the voice channel. The first input assembly can be configured to obtain the voice of the present party object and the other party object in the voice channel to obtain the input data. The other party object can propose the descriptive data representing the restrictive condition to the present party object. For example, the other party object can send the descriptive data to the present party object through SMS. Then, the descriptive data representing the restrictive condition can be obtained through the second input assembly. The first input assembly can be the voice parse assembly in the electronic device and can be configured to parse the voice of both parties in the call to obtain the input data. The second input assembly can be the data parse assembly of the electronic device and can be configured to parse the SMS sent by the other party object to obtain the descriptive data.

In some embodiments, in a voice call scenario between the at least two party objects, the first input assembly can be configured to obtain the voice of the present party object and the other party object in the voice channel to obtain the input data. The other party object can propose the descriptive data representing the restrictive condition. For example, the present party object can select whether to restrict the voice through the prompt box that pops up at the touch screen of the electronic device. The descriptive data of the present party object can be obtained by the second input assembly. The second input assembly can be the touch screen. For another example, the electronic device can be a computer. The present party object can determine the descriptive data through the input of the mouse or keyboard of the electronic device. The second input assembly can be an assembly responding to the mouse or the keyboard.

In some embodiments, in a voice call scenario between the at least two party objects, the call content of both parties can include the descriptive data representing the restrictive condition. For example, the other party object can directly state during the call that identity information in the voice call cannot be processed. Then, the input data and the descriptive data are from the voice call, and only one input assembly is needed to obtain the input data and the descriptive data representing the restrictive condition.

In some embodiments, the input data and the descriptive data can be from the same user. The input data can be voice, video, or text saved by the user, and the descriptive data can be set by the user for the voice, video, or text that needs to be processed. For example, if the input data and descriptive data are voice segments, the same input assembly can be configured to obtain the input data and the descriptive data. The input assembly can be a voice parsing assembly. For another example, if the input data is voice, and the descriptive data is text, the first input assembly can be configured to obtain the input data, and the second input assembly can be configured to obtain the descriptive data. The first input assembly can be a voice parsing assembly, and the second input assembly can be a text parsing assembly.

In some embodiments, the processor can be communicatively connected to the first input assembly and the second input assembly. After the first input assembly obtains the input data, and the second input assembly obtains the descriptive data, the processor can be configured to process the input data based on the target model, input data, and descriptive data to generate the output data. The target model can be the generative large language model. The generative large language model can be configured to summarize the input data to obtain the summary corresponding to the input data. For example, the processor can be configured to call the target model, input the input data and descriptive data into the target model, run the target model, and obtain the output data.

In some embodiments, after the processor processes the input data, the output assembly can be configured to output the output data. The output data can be the final processed data of the input data and may not include the target data corresponding to the restrictive condition. For example, the output data can be a summary text, and the output assembly can be a text generation assembly of the electronic device.

In some embodiments, the electronic device can further include a memory used to store the target model. The processor 1030 can be further configured to load and execute the target model from the memory.

The target model can be stored in the memory of the electronic device. The processor can access the memory, load the target model from the memory into the internal memory, and execute the target model.

In some embodiments, the first input assembly 1010 can be further configured to obtain the information input of the at least two party objects to form the input data. The second input assembly 1020 can be configured to obtain the restrictive condition input by the at least one party object of the at least two party object to form the descriptive data.

In some embodiments, the restrictive conditions from the first party can be applied to the part of the input data that belongs to the first party object.

In some embodiments, the first input assembly 1010 can be further configured to establish the communication channel with the at least one party object, obtain the information input of the present party object and the information input of the other party object to form the input data, and analyze the input data to determine the restrictive condition input by the at least one party object of the present party object and the other party object.

In some embodiments, the first input assembly 1010 can be further configured to, if the communication channel is successfully established with the at least one party object, obtain the restrictive condition input by the other party object, if the communication channel is disconnected with the at least one party object, obtain the restrictive condition input by the other party object, and obtain the restrictive condition input by the other party object during the communication based on the communication channel with the at least one party object.

In some embodiments, the second input assembly 1020 can be further configured to obtain the descriptive data representing the restrictive condition in response to calling the target model.

In some embodiments, the processor 1030 can be further configured to process the input data based on the descriptive data to obtain the vector data to be input into the target model. Processing the input data based on the descriptive data can include cleaning the data that meets the restrictive condition from the input data. The processor 1030 can be further configured to process the vector data based on the target model to generate the output data.

In some embodiments, the processor 1030 can be further configured to process the input data into the first vector data, process the descriptive data into the second vector data, and process the first vector data and the second vector data based on the target model to generate the output data. When generating the output data, the target model can clean the vector data that meets the restrictive condition. The restrictive condition can be used to restrict the processing process of the target model.

FIG. 11 illustrates a schematic diagram of a computer device 1100 according to embodiments of the present disclosure. As shown in FIG. 11, the hardware entity of the computer device 1100 includes a processor 1101 and a memory 1102. The memory 1102 stores a computer program that, when executed by the processor 1101, causes the processor 1101 to implement the steps of the method above.

The memory 1102 can store the computer program that can be executed by the processor. The memory 1102 can be configured to store instructions and applications executable by the processor 1101 and also cache data to be processed or already processed by the processor 1101 and various modules in the computer device 1100 (e.g., image data, voice data, voice communication data, and video communication data), which can be stored in flash memory (FLASH) or random access memory (RAM).

When the processor 1101 executes the program, the steps of any of the data processing methods above can be implemented. The processor 1101 usually controls the overall operation of the computer device 1100.

Embodiments of the present disclosure provide a computer storage medium storing one or more programs that, when executed by the processor, causes the processor to implement the steps of the data processing methods above.

The descriptions of the above storage medium and device embodiments are similar to the descriptions of the above method embodiments and have similar beneficial effects. For the technical details not disclosed in the storage medium and device embodiments of the present disclosure, reference can be made to the description of the method embodiments of the present disclosure.

The processor above can include at least one of an Application Specific Integrated Circuit (ASIC), Digital Signal Processor (DSP), Digital Signal Processing Device (DSPD), Programmable Logic Device (PLD), Field Programmable Gate Array (FPGA), Central Processing Unit (CPU), controller, microcontroller, or microprocessor. The electronic device implementing the functions of the processor can include other types, which are not limited here.

The computer storage medium/memory above can include Read-Only Memory (ROM), Programmable Read-Only Memory (PROM), Erasable Programmable Read-Only Memory (EPROM), Electrically Erasable Programmable Read-Only Memory (EEPROM), Ferromagnetic Random Access Memory (FRAM), Flash Memory, magnetic surface memory, optical disk, or Compact Disc Read-Only Memory (CD-ROM), or various terminals including one of the above memories or any combination thereof, such as a mobile phones, computer, tablet device, personal digital assistant, etc.

The above description illustrates only some embodiments of the present disclosure. However, the scope of the present disclosure is not limited to this. Those skilled in the art can easily think of modifications or replacements to embodiments of the present disclosure. These modifications and replacements are within the scope of the present disclosure.

What is claimed is:

1. A data processing method comprising:
obtaining input data;
obtaining descriptive data representing a restrictive condition, the input data including target data corresponding to the restrictive condition;
based on a target model, the input data, and the descriptive data, processing the input data to generate output data, the target model being a generative large language model; and
outputting the output data, the output data excluding the target data corresponding to the restrictive condition.

2. The method according to claim 1, wherein:
obtaining the input data includes:
obtaining information input of at least two party objects to form the input data; and
obtaining the descriptive data used to represent the restrictive condition includes:
obtaining the restrictive condition input by at least one party object of the at least two party objects to form the descriptive data.

3. The method according to claim 2, further comprising:
applying a restrictive condition from a first party object to a part of the input data belonging to the first party object.

4. The method according to claim 3, wherein:
obtaining the information input of the at least two party objects to form the input data includes:
establishing a communication channel with at least one party object; and
obtaining information input of a present party object and information input of an other party object to form the input data, the other party object belonging to the at least one party object; and
obtaining the restrictive condition input by the at least one party object of the at least two party objects to form the descriptive data includes:
analyzing the input data to determine the restrictive condition input by the at least one party object of the present party object and the other party object.

5. The method according to claim 3, wherein:
obtaining the information input of the at least two party objects to form the input data includes:
establishing the communication channel with the at least one party object; and
obtaining information input of the present party object and information input of the other party object to form the input data, the other party object belonging to the at least one party object; and
obtaining the restrictive condition input by the at least one party object of the at least two party objects to form the descriptive data includes at least one of:
in response to the communication channel with the at least one party object being successfully established, obtaining the restrictive condition input by the other party object;
in response to the communication channel with the at least one party object being disconnected, obtaining the restrictive condition input by the other party object; or
obtaining the restrictive condition input by the other party object during communication based on the communication channel established with the at least one party object.

6. The method according to claim 1, wherein obtaining the descriptive data used to represent the restrictive condition further includes:
in response to calling the target model, obtaining the descriptive data used to represent the restrictive condition.

7. The method according to claim 1, wherein based on the target model, the input data, and the descriptive data, processing the input data to generate the output data includes:
processing the input data based on the descriptive data to obtain vector data used to be input into the target model, including cleaning data that meets the restrictive condition from the input data; and
processing the vector data based on the target model to generate the output data.

8. The method according to claim 1, wherein based on the target model, the input data, and the descriptive data, processing the input data to generate the output data includes:
processing the input data into first vector data;
processing the descriptive data into second vector data; and
processing the first vector data and the second vector data based on the target model to generate the output data, the target model being configured to clean vector data that meets the restrictive condition when generating the output data, the restrictive condition being used to restrict a processing process of the target model.

9. An electronic device comprising:
a first input assembly configured to obtain the input;
a second input assembly configured to obtain descriptive data representing a restrictive condition, the input data including target data corresponding to the restrictive condition;
one or more processors configured to, based on a target model, the input data, and the descriptive data, process the input data to generate output data, the target model being a generative large language model; and
an output assembly configured to output the output data, the output data excluding the target data corresponding to the restrictive condition.

10. The device according to claim 9, further comprising one or more memories storing the target model, wherein:
the one or more processors are further configured to load and execute the target model from the one or more memories.

11. The device according to claim 9, wherein:
the first input assembly is further configured to:
obtain information input of at least two party objects to form the input data; and
the second input assembly is further configured to:
obtain the restrictive condition input by at least one party object of the at least two party objects to form the descriptive data.

12. The device according to claim 11, wherein the one or more processors are further configured to:
apply a restrictive condition from a first party object to a part of the input data belonging to the first party object.

13. A non-transitory computer-readable storage medium storing a computer program that, when executed by one or more processors, causes the one or more processors to:
obtain input data;
obtain descriptive data representing a restrictive condition, the input data including target data corresponding to the restrictive condition;
based on a target model, the input data, and the descriptive data, process the input data to generate output data, the target model being a generative large language model; and
output the output data, the output data excluding the target data corresponding to the restrictive condition.

14. The storage medium according to claim 13, wherein the one or more processors are further configured to:
obtain information input of at least two party objects to form the input data; and
obtain the restrictive condition input by at least one party object of the at least two party objects to form the descriptive data.

15. The storage medium according to claim 14, wherein the one or more processors are further configured to:
apply a restrictive condition from a first party object to a part of the input data belonging to the first party object.

16. The storage medium according to claim 15, wherein the one or more processors are further configured to:
establish a communication channel with at least one party object;
obtain information input of a present party object and information input of an other party object to form the input data, the other party object belonging to the at least one party object; and
analyze the input data to determine the restrictive condition input by the at least one party object of the present party object and the other party object.

17. The storage medium according to claim 14, wherein the one or more processors are further configured to:
establishing the communication channel with the at least one party object; and
obtaining information input of the present party object and information input of the other party object to form the input data, the other party object belonging to the at least one party object; and
in response to the communication channel with the at least one party object being successfully established, obtaining the restrictive condition input by the other party object;
in response to the communication channel with the at least one party object being disconnected, obtaining the restrictive condition input by the other party object; or
obtaining the restrictive condition input by the other party object during communication based on the communication channel established with the at least one party object.

18. The storage medium according to claim 13, wherein the one or more processors are further configured to:
in response to calling the target model, obtain the descriptive data used to represent the restrictive condition.

19. The storage medium according to claim 13, wherein the one or more processors are further configured to:
process the input data based on the descriptive data to obtain vector data used to be input into the target model, including cleaning data that meets the restrictive condition from the input data; and
process the vector data based on the target model to generate the output data.

20. The storage medium according to claim 13, wherein the one or more processors are further configured to:
process the input data into first vector data;
process the descriptive data into second vector data; and
process the first vector data and the second vector data based on the target model to generate the output data, the target model being configured to clean vector data that meets the restrictive condition when generating the output data, the restrictive condition being used to restrict a processing process of the target model.
